(19) United States
(12) Patent Application Publication
(10) Pub. No.: US 2022/0318813 A1
(43) Pub. Date: Oct. 6, 2022

(54) METHOD FOR PROCESSING BANK TRANSACTIONS AND ELECTRONIC DEVICE USING METHOD

(71) Applicant: Fulian Precision Electronics (Tianjin) Co., LTD., Tianjin (CN)

(72) Inventor: CHUN-CHIH YANG, Taipei City (TW)

(21) Appl. No.: 17/386,938

(22) Filed: Jul. 28, 2021

(30) Foreign Application Priority Data
Apr. 1, 2021 (CN) 202110358095.4

(51) Int. Cl. G06Q 20/40; G06Q 20/10

(52) U.S. Cl. CPC G06Q 20/40145; G06Q 20/1085

(57) ABSTRACT

A method for processing financial transactions through a financial authority such as a bank sends a target transaction authorization request from a first ATM or other terminal to a server of the bank. The bank server sends a biometric authentication request to a second terminal recorded as being held by the client desiring the transaction, for example the client's smartphone. The second terminal authenticates the client by reference to its own data and sends an authorization instruction to the first terminal upon successful authentication, the target transaction being then permitted by the bank server. The biometric identification in the second terminal is utilized to perform authentication without uploading private data of the client to the server, thereby improving transaction security. A terminal device and a non-volatile storage medium therein are also disclosed.

### FIELD

The subject matter herein generally relates to data management, smart payments, and an electronic device.

### BACKGROUND

In order to prevent fraudulent transactions during the transaction process, the existing technology provides ATM cash machines with fingerprint recognition function, and customers need to pass fingerprint recognition to withdraw money. However, the bank itself did not require customers to provide fingerprints for file creation, nor did they mandate fingerprint identification when withdrawing funds, which is very low transaction security.

Therefore, there is a room for improvement.

### BRIEF DESCRIPTION OF THE DRAWINGS

Implementations of the present disclosure will now be described, by way of embodiments, with reference to the attached figures.

FIG. 1 is flowchart of an embodiment of a transaction processing method according to the present disclosure.

FIG. 2 is flowchart of another embodiment of the transaction processing method according to the present disclosure.

FIG. 3 is flowchart of another embodiment of the transaction processing method according to the present disclosure.

FIG. 4a is flowchart of another embodiment of the transaction processing method according to the present disclosure.

FIG. 4b is flowchart of an embodiment of the authentication process of the transaction processing method according to the present disclosure.

FIG. 5a is schematic diagram of an embodiment of the data flow of the ATM withdrawal transaction processing method according to the present disclosure.

FIG. 5b is schematic diagram of another embodiment of a data flow of the ATM withdrawal transaction processing method according to the present disclosure.

FIG. 6a is schematic diagrams of an embodiment of the data flow of a credit card transaction processing method according to the present disclosure.

FIG. 6b is schematic diagrams of another embodiment of the data flow of a credit card transaction processing method according to the present disclosure.

FIG. 7 is schematic diagram of an embodiment of a terminal device according to the present disclosure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

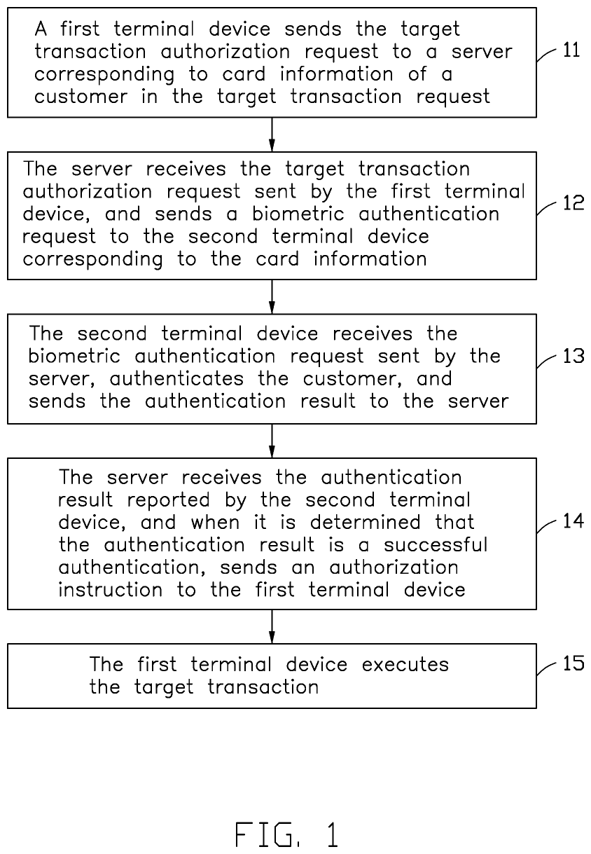

FIG. 1 shows a flow chart of one embodiment of a method for processing transactions of the present disclosure.

In one embodiment, the method can be applied to a terminal device. For a terminal device which processes transactions, the function for transaction processing provided by the method of the present disclosure can be directly integrated on the terminal device, or run on the terminal device in the form of a software development kit (SDK).

As shown in FIG. 1, the method according to the embodiment of the present disclosure includes the following steps:

At block 11, a first terminal device sends a target transaction authorization request to a server corresponding to card information of a customer in the target transaction request according to the received target transaction request.

In the embodiment, when a customer intends to make a target transaction, the customer triggers a target transaction request at the first terminal device. Specifically, the first terminal device may be an ATM cash machine or a credit card machine. In the embodiment, the target transaction request includes the card information of the customer. The card information includes issuing bank, registered mobile phone number, customer name, ID number, and other information.

In the embodiment, the first terminal device sends the target transaction authorization request to the server in response to the target transaction request. The target transaction may include: using a credit card or other financial card for transfer, withdrawal, or payment transactions, the server can be a card issuing bank subsystem. The server receives the target transaction authorization request, and sends the target transaction authorization request to the server corresponding to the card information according to the target transaction authorization request. For example, if the card information is a Ping An Bank financial card, the target transaction authorization request is sent to the Ping An Bank server.

In the embodiment, the first terminal device only needs to send a target transaction authorization request and receive a target transaction authorization instruction, and does not need to perform biometric identification, so there is no need to build a biometric identification module, which reduces the cost of transaction processing. Since different servers process transactions corresponding to the card information, the target transaction authorization request is sent to the server corresponding to the card information, avoiding confusion during a transaction process, and improving transaction processing efficiency.

At block 12, the server receives the target transaction authorization request sent by the first terminal device, and sends a biometric authentication request to the second terminal device corresponding to the card information according to the target transaction authorization request.

In the embodiment, the server receives the target transaction authorization request sent by the first terminal device. The biometric authentication request is used to request the identity authentication of the customer during the transaction. For example, the authentication request can be sent to the second terminal device corresponding to the mobile phone number according to the mobile phone number registered in the card information. The customer's smartphone sends the biometric authentication request, and the customer's biometric identity is authenticated on the customer's smartphone.

At block 13, the second terminal device receives the biometric authentication request sent by the server, authenticates the customer according to the biometric authentication request, and sends the authentication result to the server.

In the embodiment, the second terminal device may be a smart phone, an IPAD, or other devices that have a biometric identification function. The biometric features can include, but are not limited to, face information, fingerprint information, voiceprint information, iris of eye information, and palmprint information.

The embodiment of the present disclosure uses the existing biometric identification technology of the second terminal device to perform identity authentication for the customer, without cost of making credit cards and financial cards with a built-in biometric identification module. The customer's biometrics are stored in the second terminal device, which is kept by the customer. There is no need to upload the customer's biometrics data to the server for authentication, which improves the efficiency of authentication. If the second terminal device is lost, the affected area is limited to that customer only, which improves transaction security.

In one embodiment, authenticating the customer according to the biometric authentication request and sending the authentication result to the server includes:

Identifying the request type of the biometric authentication request;

When the request type is a first type, parsing the biometric authentication request to obtain the authentication type;

When the authentication type is fingerprint authentication, acquiring a first fingerprint collected by a collection device, and performing fingerprint authentication on the first fingerprint;

Determining whether a first customer corresponding to a first fingerprint and a second customer corresponding to a second fingerprint in a preset fingerprint library are the same customer;

When the first customer corresponding to the first fingerprint and the second customer corresponding to the second fingerprint in the preset fingerprint library are the same customer, the successful authentication is reported to the server.

In the embodiment, since the first type is that the second terminal device does not need to log in to the card issuing bank APP corresponding to the card information, the biometric authentication request can be analyzed to obtain the authentication type.

The authentication types may include, but are not limited to, fingerprint authentication, face authentication, voiceprint authentication, iris authentication, and palmprint authentication.

The embodiment of the present disclosure performs authentication through different authentication types, which improves the diversity and flexibility of transaction processing authentication.

In the embodiment, a collection device is installed in the second terminal device, and the first fingerprint is collected by activating the collection device in the second terminal device. The first fingerprint is the fingerprint of the current customer, and when the first fingerprint of the current customer is collected, fingerprint authentication is performed on the first fingerprint.

In the embodiment, since the second terminal device has a built-in biometric identification module, a fingerprint library can be created in advance in the second terminal device. The second fingerprint of the customer holding the second terminal device is stored in the pre-created fingerprint library, and the first fingerprint is matched with the second fingerprint in the preset fingerprint library, in determining whether the first customer corresponding to the first fingerprint and the second customer corresponding to the second fingerprint in the preset fingerprint library are the same customer. Since the second fingerprint of the customer is stored in the second terminal device and kept by the customer, there is no need to upload the second fingerprint of the customer to the server for authentication, which improves the authentication efficiency. If the second terminal device is lost, only that customer is affected, which improves transaction security.

The method further includes:

When the first customer corresponding to the first fingerprint and the second customer corresponding to the second fingerprint in the preset fingerprint library are not the same customer, the non-authentication is reported to the server.

In the embodiment, the transaction is only performed after the authentication is successful, which improves the security of the transaction.

The method further includes:

Acquiring the first face feature collected by the collection device and performing face authentication on the first face feature when the authentication type is face authentication;

Determining whether the first customer corresponding to the first face feature and the second customer corresponding to the second face feature in the preset face feature library are the same customer;

When the first customer corresponding to the first face feature and the second customer corresponding to the second face feature in the preset face feature library are the same customer, the successful authentication is reported to the server.

The method further includes:

When the first customer corresponding to the first face feature and the second customer corresponding to the second face feature in the preset face feature library are not the same customer, the authentication failure is reported to the server.

In the embodiment, since there are multiple types of authentication, different biometrics features can be collected for authentication according to different authentication types, which improves the diversity and flexibility of transaction authentication.

In other embodiment, the method further includes:

When the request type is the second type, parsing the biometric authentication request to obtain the target authentication type and the customer's card information;

Displaying the login interface of the corresponding card issuing bank APP according to the customer's card information;

When a log-in success message is monitored, the corresponding target biometric feature is collected in the card issuing bank APP according to the target authentication type;

Comparing the target biometric feature with the target biometric feature in a preset target database;

When the target biometric feature matches the target biometric feature in the preset target database, reporting a successful authentication to the server; or

When the target biometric feature does not match the target biometric feature in the preset target database, non-authentication is reported to the server.

In the embodiment, since the second type requires the second terminal device to log in to the card issuing bank APP corresponding to the card information, thus when the identification request type is the second type, logging in according to the card information of the customer to display the corresponding login interface of the card issuing bank APP, collecting the corresponding target biometrics according to the authentication type, and collecting the target biometric feature in the card-issuing bank APP, comparing the collected target biometric feature with the target biometric feature in the preset target database, and determining whether the authentication is successful or otherwise.

In the embodiment, when the request type is the second type, the login authentication of the issuing bank APP is first performed, then the target biometric authentication is carried out after the login is successful, and the authentication or non-authentication is based on two-factor authentication, which further improves the transaction security.

At block 14, the server receives the authentication result reported by the second terminal device, and when it is determined that the authentication is successful, sending an authorization instruction to the first terminal device.

In the embodiment, when the second terminal device performs the biometric authentication of the customer, it sends an authentication result to the server. Specifically, the result can be authentication success and non-authentication.

In the embodiment, the server determines whether to send an authorization or reject an authorization command according to the authentication result.

The method further includes:

When the server determines that the result is non-authentication, sending an authorization rejection instruction to the first terminal device;

The first terminal device displays target transaction failure information according to the authorization rejection instruction.

In the embodiment, when the authentication is successful, the authorization instruction is sent to the first terminal device. When the first terminal device receives the authorization instruction, the target transaction is executed. When the result received by the server is non-authentication, an authorization rejection instruction is sent to the first terminal device, and the transaction failure information is displayed through the first terminal device.

Exemplarily, the first terminal device is an ATM cash machine, the server is the card issuing bank subsystem, and the second terminal device is a smart phone. When a customer uses a financial card to withdraw money at an ATM cash machine, the ATM cash machine sends a withdrawal authorization request to the card issuing bank subsystem. When the card issuing bank subsystem receives the withdrawal authorization request, it sends a biometric authentication request to the smartphone corresponding to the financial card according to the withdrawal authorization request. The smart phone performs biometric authentication on the customer according to the biometric authentication request. After the biometric authentication result is correct, the issuing bank subsystem sends an authorization instruction to the ATM cash machine, and permits the withdrawal at the ATM cash machine, which improves transaction processing safety.

In block 15, the first terminal device executes the target transaction according to the authorization instruction.

In the embodiment, the instructions received by the first terminal device include an authorization instruction and an authorization rejection instruction.

When the server determines that the result is non-authentication, sending an authorization rejection instruction to the first terminal device;

The first terminal device displays the target transaction failure information according to the authorization rejection instruction.

In the embodiment, the first terminal device determines whether to execute the target transaction according to the received instruction, and performs the transaction when the authorization instruction is received, which improves the security of the target transaction.

In summary, in the transaction processing method described in the embodiment of the present disclosure, on the one hand, the first terminal device only needs to send a target transaction authorization request and receive a target transaction authorization instruction, and does not need to perform biometric identification. Thereby, no built-in biometric identification module is required, reducing the cost of transaction processing. Since different servers process transactions corresponding to the card information, the target transaction authorization request is sent to the server corresponding to the card information, avoiding transaction confusion during the transaction process, and improving transaction processing efficiency. On the other hand, a biometric authentication request is sent to the second terminal device corresponding to the card information for biometric authentication according to the target transaction authorization request, and the existing biometric identification technology of the second terminal device is used to authenticate the customer. The cost of making credit card and financial card with built-in biometric identification module is saved, and the customer's biometrics are stored in the second terminal device, which is kept by the customer, without uploading the customer's biometric data to the server. If the second terminal device is lost, only that customer is affected, which improves transaction security. Finally, since there are multiple authentication types, different biometrics are collected for authentication according to different authentication types, which improves the diversity and flexibility of transaction authentication.

In addition, when the request type is the second type, the card issuing bank's APP login authentication is performed first, and the target biometric authentication is performed after the login is successful. After two-factor authentication, the authentication result is obtained, which further improves the transaction security.

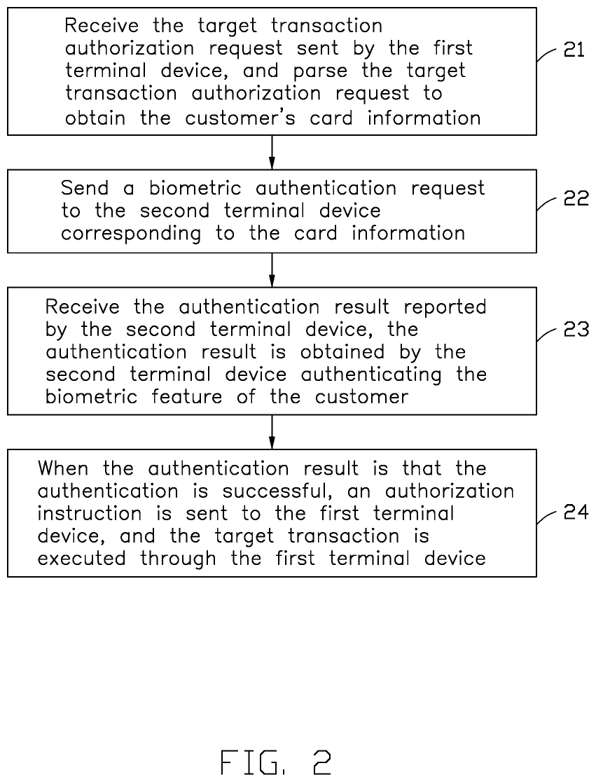

FIG. 2 shows a flow chart of another embodiment of a transaction processing method of the present disclosure.

As shown in FIG. 2, the transaction processing method is applied to the server, and specifically includes the following steps.

At block 21, receiving the target transaction authorization request sent by the first terminal device, and parsing the target transaction authorization request to obtain the customer's card information.

In the embodiment, when the customer is to perform a target transaction, a target transaction request is triggered on the first terminal device. The first terminal device sends a target transaction authorization request to the server in response to the target transaction request. The target transaction may include: using a credit or financial card for transfer, withdrawal, or payment transactions. The first terminal device may be an ATM cash machine or a credit card machine, and the server may be a card issuing bank subsystem. The server receives the target transaction authorization request, and parses the transaction authorization request to obtain the customer's card information. The card information includes: issuing bank, registered mobile phone number, customer name, ID card number, and other information.

In the embodiment, the first terminal device only needs to send a target transaction authorization request and receive a target transaction authorization instruction, and does not need to perform biometric identification, so there is no need to provide a biometric identification module, which reduces the cost of transaction processing.

At block 22, sending a biometric authentication request to the second terminal device corresponding to the card information according to the target transaction authorization request.

In the embodiment, the second terminal device may be a smart phone, an IPAD, or other device that has a biometric identification function. The biometric features can include, but are not limited to, face information, fingerprint information, voiceprint information, iris information, and palmprint information.

In the embodiment, the biometric authentication request is used to request the authentication of the customer during the transaction process.

This embodiment of the present disclosure uses the existing biometric identification technology of the second terminal device to perform identity authentication for the customer, without more cost in making credit cards and financial cards with a built-in biometric identification module. The customer's biometrics are stored in the second terminal device, which is kept by the customer. There is no need to upload the customer's biometrics data to the server for authentication, which improves the efficiency of authentication. If the second terminal device is lost, the affected area is limited to that customer, which improves transaction security.

At block 23, receiving the authentication result reported by the second terminal device, where the result is obtained by the second terminal device authenticating the biometric feature of the customer.

In the embodiment, when the second terminal device performs the biometric authentication of the customer, it sends a result to the server. Specifically, the authentication result can include successful authentication and non-authentication.

At block 24, when the authentication result is that the authentication is successful, an authorization instruction is sent to the first terminal device, and the target transaction is executed through the first terminal device.

In the embodiment, the server determines whether to send an authorization or reject the authorization command according to the authentication result.

When the authentication result is non-authentication, an authorization rejection instruction is sent to the first terminal device, and the target transaction failure information is displayed through the first terminal device.

In the embodiment, when the authentication result received by the server is successful authentication, the authorization instruction is sent to the first terminal device. When the first terminal device receives the authorization instruction, the target transaction is executed. When the result received by the server is non-authentication, it sends an authorization rejection instruction to the first terminal device, and displays the transaction failure information through the first terminal device.

Exemplarily, the first terminal device is an ATM cash machine, the server is the card issuing bank subsystem, and the second terminal device is a smart phone. When a customer uses a financial card to withdraw money at an ATM cash machine, the ATM cash machine sends a withdrawal authorization request to the card issuing bank subsystem. When the card issuing bank subsystem receives the withdrawal authorization request, it sends a biometric authentication request to the smartphone corresponding to the financial card according to the withdrawal authorization request. The smart phone performs biometric authentication on the customer according to the biometric authentication request. After the biometric identification is authenticated successfully, the issuing bank subsystem sends an authorization instruction to the ATM cash machine, and permits the withdrawal at the ATM cash machine, which improves transaction processing safety.

On the other hand, in the transaction processing method described in the embodiment, a biometric authentication request is sent to the second terminal device corresponding to the card information for biometric authentication according to the target transaction authorization request, and the existing biometric identification technology of the second terminal device is used to authenticate the customer. The cost of making credit card and financial card with built-in biometric identification module is saved, and the customer's biometrics are stored in the second terminal device, which is kept by the customer, without uploading the customer's biometric data to the server.

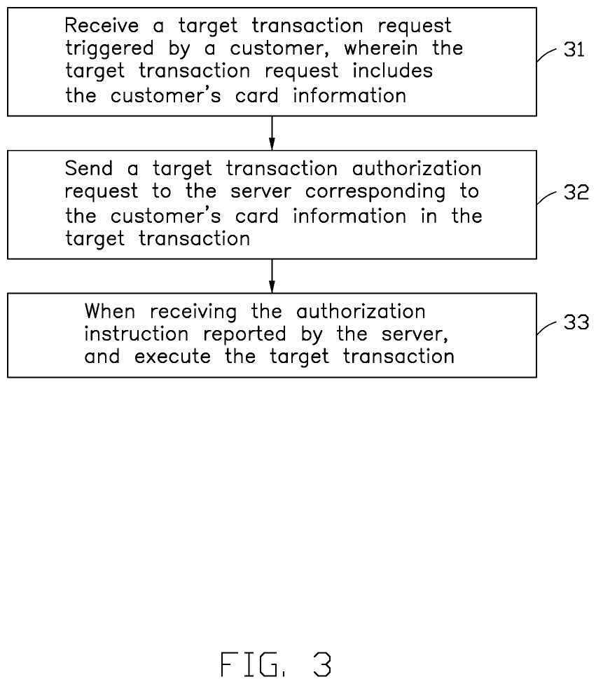

FIG. 3 shows a flow chart of another embodiment of a transaction processing method of the present disclosure.

As shown in FIG. 3, the transaction processing method is applied to the first terminal device, and specifically includes the following steps.

At block 31, receive a target transaction request triggered by a customer, wherein the target transaction request includes the customer's card information.

In the embodiment, when the customer is conducting the target transaction, the customer triggers the target transaction request on the first terminal device. The first terminal device may be an ATM cash machine or a credit card machine. In the embodiment, the target transaction request includes the customer's card information. The card information includes: issuing bank, registered mobile phone number, customer name, ID number and other information.

At block 32, send a target transaction authorization request to the server corresponding to the customer's card information in the target transaction according to the target transaction request.

In the embodiment, the first terminal device sends a target transaction authorization request to the server in response to the target transaction request. The target transaction may include: using a credit or financial card for transfer, withdrawal, or payment transactions, and the server may be a card issuing bank subsystem. The server receives the target transaction authorization request, and sends the target transaction authorization request to the server corresponding to the card information according to the target transaction authorization request. For example, if the card information is a Ping An Bank financial card, the target transaction authorization request is sent to the Ping An Bank server.

In the embodiment, the first terminal device only needs to send a target transaction authorization request and receive a target transaction authorization instruction, and does not need to perform biometric identification, so there is no need to build a biometric identification module, which reduces the cost of transaction processing. Since different servers process transactions corresponding to the card information, the target transaction authorization request is sent to the server corresponding to the card information, avoiding transaction confusion during the transaction process, and improving transaction processing efficiency.

At block 33, when receiving the authorization instruction reported by the server, and execute the target transaction according to the authorization instruction.

In the embodiment, the instruction received by the first terminal device includes an authorization instruction and an authorization rejection instruction.

When receiving the authorization rejection instruction reported by the server, display target transaction failure information according to the authorization rejection instruction.

In the embodiment, the first terminal device determines whether to execute the target transaction according to the received instruction, and performs the transaction when the authorization instruction is received, which improves the security of the target transaction.

In summary, the transaction processing method receives the target transaction request triggered by the customer, sends a target transaction authorization request to the server corresponding to the card information. The first terminal device only needs to send the target transaction authorization request and receive the target transaction authorization instruction, and does not need to perform biometric identification. Therefore, there is no need to build a biometric identification module, which reduces the cost of transaction processing.

Since different servers process transactions corresponding to the card information, the target transaction authorization request is sent to the server corresponding to the card information, avoiding transaction confusion during the transaction process, and improving transaction processing efficiency.

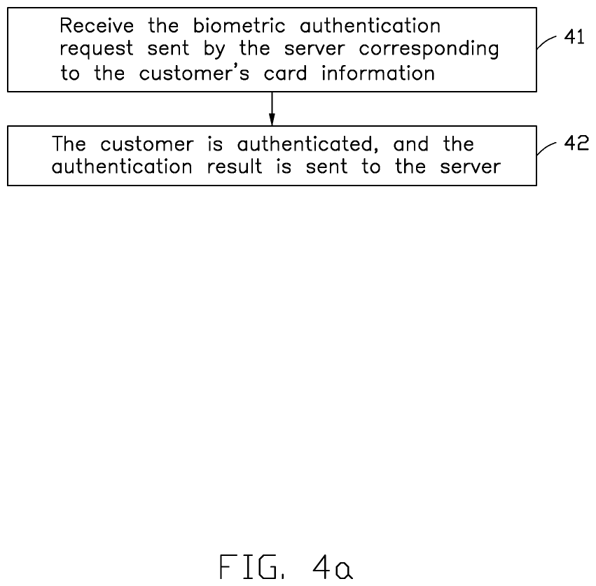

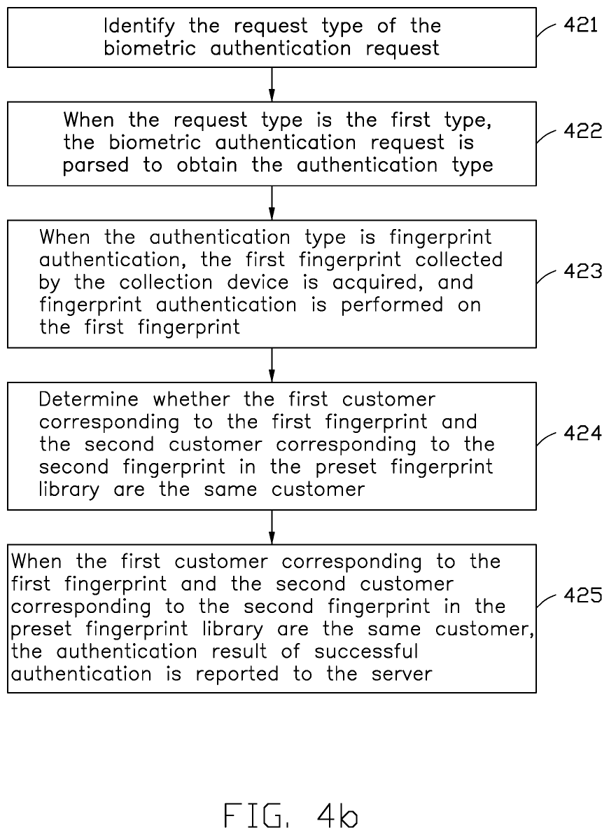

FIG. 4a shows a flow chart of another embodiment of a transaction processing method of the present disclosure.

As shown in FIG. 4a, the transaction processing method is applied to the second terminal device and specifically includes the following steps.

In block 41, receive the biometric authentication request sent by the server corresponding to the customer's card information.

In the embodiment, the transaction processing method is applied to the second terminal device. The second terminal device may be a smart phone, an IPAD or other devices that currently have a biometric identification function; the first terminal device may be an ATM cash machine or a credit card machine; the server may be a card-issuing bank subsystem.

In the embodiment, the request type includes the first type and the second type. The first type is that the second terminal device does not need to log in to the card issuing bank APP corresponding to the card information, and the second type is that the second terminal device needs to log in to the card issuing bank APP corresponding to the card information.

In the embodiment, the biometric authentication request is used to request the identity authentication of the customer during the transaction. For example, the authentication request can be sent to the second terminal device corresponding to the mobile phone number according to the mobile phone number registered in the card information. The customer's smartphone sends the biometric authentication request, and the customer's biometric identity is authenticated on the customer's smartphone

At block 42, the customer is authenticated according to the authentication request, and the authentication result is sent to the server.

In one embodiment, as shown in FIG. 4b, block 42 may include the following steps.

At block 421, identify the request type of the biometric authentication request.

At block 422, when the request type is the first type, the biometric authentication request is parsed to obtain the authentication type.

In the embodiment, since the first type is that the second terminal device does not need to log in to the card issuing bank APP corresponding to the card information, analyze the biometric authentication request to obtain the authentication type. The authentication types may include, but are not limited to, fingerprint authentication, face authentication, voiceprint authentication, iris authentication, and palmprint authentication.

The embodiment of the present disclosure performs authentication through different authentication types, which improves the diversity and flexibility of transaction processing authentication.

At block 423, when the authentication type is fingerprint authentication, the first fingerprint collected by the collection device is acquired, and fingerprint authentication is performed on the first fingerprint.

In the embodiment, the collection device is installed in the second terminal device, and the first fingerprint is collected by starting the collection device in the second terminal device. The first fingerprint is the fingerprint of the current customer, and when the first fingerprint of the current customer is collected, fingerprint authentication is performed on the first fingerprint.

At block 424, determine whether the first customer corresponding to the first fingerprint and the second customer corresponding to the second fingerprint in the preset fingerprint library are the same customer.

In the embodiment, since the second terminal device has a built-in biometric identification module, a fingerprint library can be created in the second terminal device in advance. The second fingerprint of the customer holding the second terminal device is stored in the pre-created fingerprint library, and the first fingerprint is matched with the second fingerprint in the preset fingerprint library, determine whether the first customer corresponding to the first fingerprint and the second customer corresponding to the second fingerprint in the preset fingerprint library are the same customer. Since the second fingerprint of the customer is stored in the second terminal device and kept by the customer, there is no need to upload the second fingerprint of the customer to the server for authentication, which improves the authentication efficiency. If the second terminal device is lost, the affected area is limited to the customer itself, which improves transaction security.

At block 425, when the first customer corresponding to the first fingerprint and the second customer corresponding to the second fingerprint in the preset fingerprint library are the same customer, the authentication result of successful authentication is reported to the server.

When the first customer corresponding to the first fingerprint and the second customer corresponding to the second fingerprint in the preset fingerprint library are not the same customer, the authentication result of authentication failure is reported to the server.

The embodiment of the present disclosure, the transaction is performed after the authentication result is confirmed to be correct, which improves the security of the transaction.

Further, the method further includes:

Acquire the first face feature collected by the collection device and performing face authentication on the first face feature when the authentication type is face authentication;

Determine whether the first customer corresponding to the first face feature and the second customer corresponding to the second face feature in the preset face feature library are the same customer;

When the first customer corresponding to the first face feature and the second customer corresponding to the second face feature in the preset face feature library are the same customer, the authentication result of successful authentication is reported to the server; or

When the first customer corresponding to the first face feature and the second customer corresponding to the second face feature in the preset face feature library are not the same customer, the authentication result of the authentication failure is reported to the server.

In the embodiment, since there are multiple authentication types, different biometrics feature is collected for authentication according to different authentication types, which improves the diversity and flexibility of transaction authentication.

In other embodiment, the method further includes:

When the request type is the second type, parsing the biometric authentication request to obtain the target authentication type and the customer's card information;

Display the login interface of the corresponding card issuing bank APP according to the customer's card information;

When a log-in success message is monitored, the corresponding target biometric feature is collected in the card issuing bank APP according to the target authentication type;

Compare the target biometric feature with the target biometric feature in a preset target database;

When the target biometric feature matches the target biometric feature in the preset target database, report the authentication result of successful authentication to the server; or

When the target biometric feature does not match the target biometric feature in the preset target database, the authentication result of the authentication failure is reported to the server.

In the embodiment, since the second type is the second terminal device that needs to log in to the card issuing bank APP corresponding to the card information, when the identification request type is the second type, log in according to the card information of the customer to display the corresponding login interface of the card issuing bank APP, collect the corresponding target biometrics according to the authentication type, and collect the target biometric feature in the card-issuing bank APP, compare the collected target biometric feature with the target biometric feature s in the preset target database, and determine whether the authentication is passed according to the comparison result.

In the embodiment, when the request type is the second type, first perform the login authentication of the issuing bank APP, then perform the target biometric authentication after the login is successful, and obtain the authentication result after two-factor authentication, which further improves the transaction security.

In summary, the transaction processing method described in the embodiment, on the one hand, when the authentication type is fingerprint authentication, the first fingerprint collected by the collection device is acquired, and determine whether the first customer corresponding to the first fingerprint and the second customer corresponding to the second fingerprint in the preset fingerprint library are the same customer. Since the second terminal device has a built-in biometric identification module, the customer's second fingerprint is stored in the second terminal device and kept by the customer. There is no need to upload the customer's second fingerprint to the server for authentication, which improves authentication efficiency. If the second terminal device is lost, the affected area is limited to the customer itself, which improves transaction security. On the other hand, since the existence of multiple authentication types, different biometrics are collected for authentication according to different authentication types, which improves the diversity and flexibility of transaction authentication. Finally, when the request type is the second type, the card issuing bank's APP login authentication is performed first, and the target biometric authentication is performed after the login is successful. After two-factor authentication, the authentication result is obtained, which further improves the transaction security.

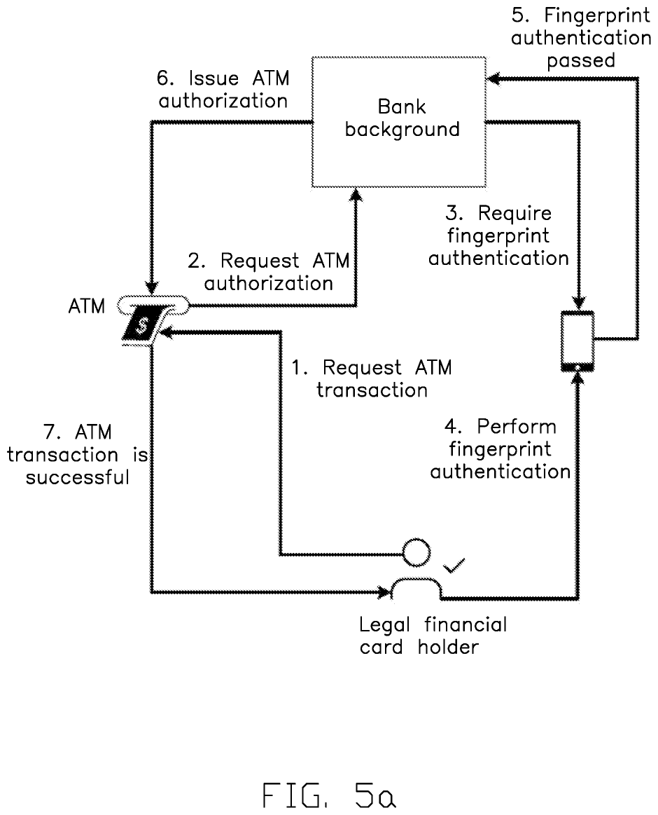

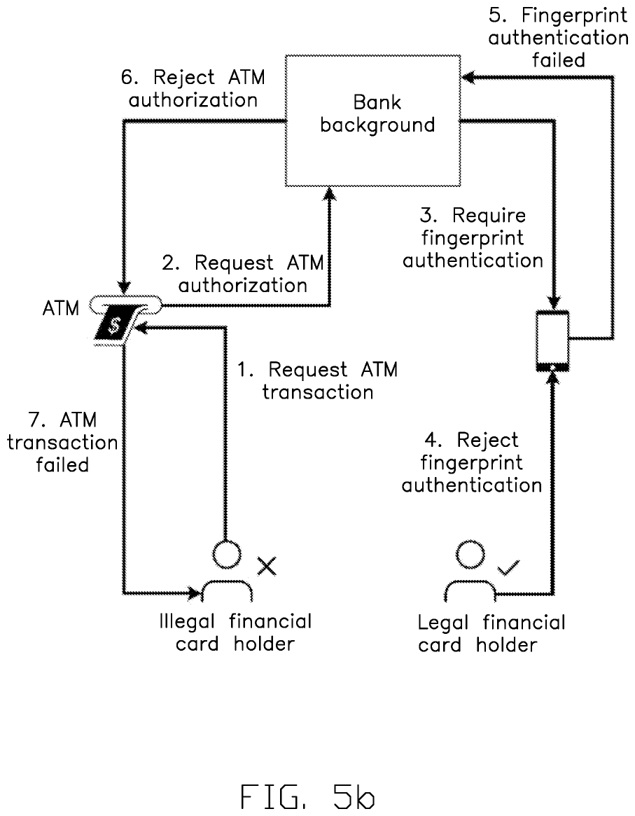

FIGS. 5a and 5b shows a flow chart of an embodiment of a ATM withdrawal transaction processing method of the present disclosure.

When the customer is a legal financial card holder of a financial card, when processing an ATM withdrawal transaction, as shown in FIG. 5a, the first terminal device is an ATM cash machine, the second terminal device is a smart phone corresponding to a financial card, and the server is a bank back office corresponding to the issuing bank of the financial card. Such authorized holder triggers a withdrawal request, requests the ATM cash machine for authorization, and sends the ATM cash machine authorization request to the bank background corresponding to the bank that issued the financial card, the bank background receives the ATM cash machine authorization request, and sends the fingerprint authentication request to the smart phone corresponding to the financial card, the smartphone receives the fingerprint authentication request and performs fingerprint authentication on the legal financial card holder. When the fingerprint authentication in the smart phone is successful, the message of successful fingerprint authentication is sent to the bank background, the bank background issues an ATM authorization instruction to the ATM cash machine, and the ATM cash machine executes the withdrawal according to the authorization instruction, and the withdrawal transaction is successful.

When the customer is an illegal financial card holder of a financial card, the ATM transaction is being processed, as shown in FIG. 5b, the first terminal device is an ATM cash machine, the second terminal device is a smart phone corresponding to a financial card, and the server is a bank background corresponding to the issuing bank of the financial card. The illegal financial card holder triggers the target transaction request, requests the ATM cash machine authorization, and sends the ATM cash machine authorization request to the bank background corresponding to the issuing bank of the financial card. The bank background receives the ATM cash machine authorization request, and sends the fingerprint authentication request to the smart phone. The smartphone receives the fingerprint authentication request and performs fingerprint authentication on the illegal financial card holder according to the fingerprint authentication request. When the smartphone corresponding to the financial card refuses fingerprint authentication, send a fingerprint authentication failure message to the bank background. The bank background issues an ATM authorization rejection instruction to the ATM cash machine, and the ATM cash machine refuses to execute the withdrawal according to the authorization rejection instruction, and the withdrawal transaction fails.

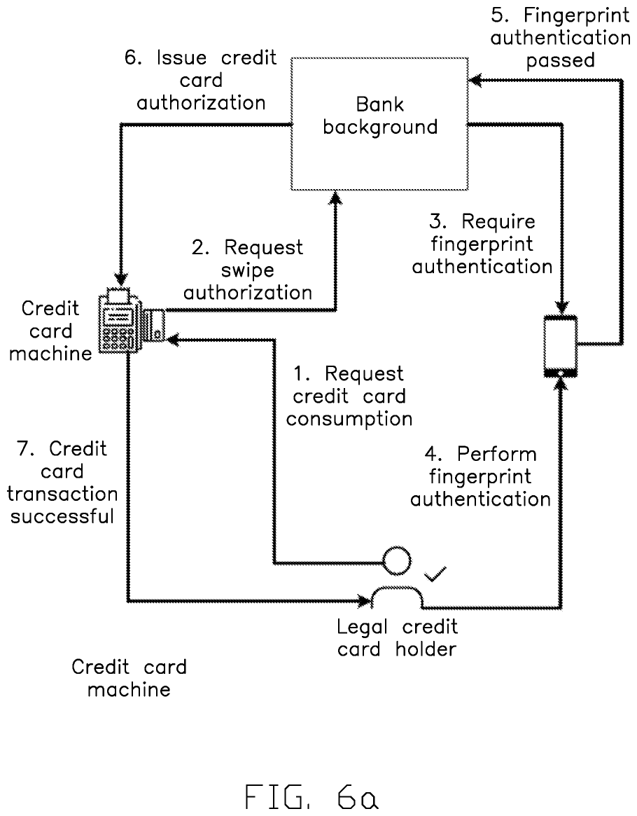

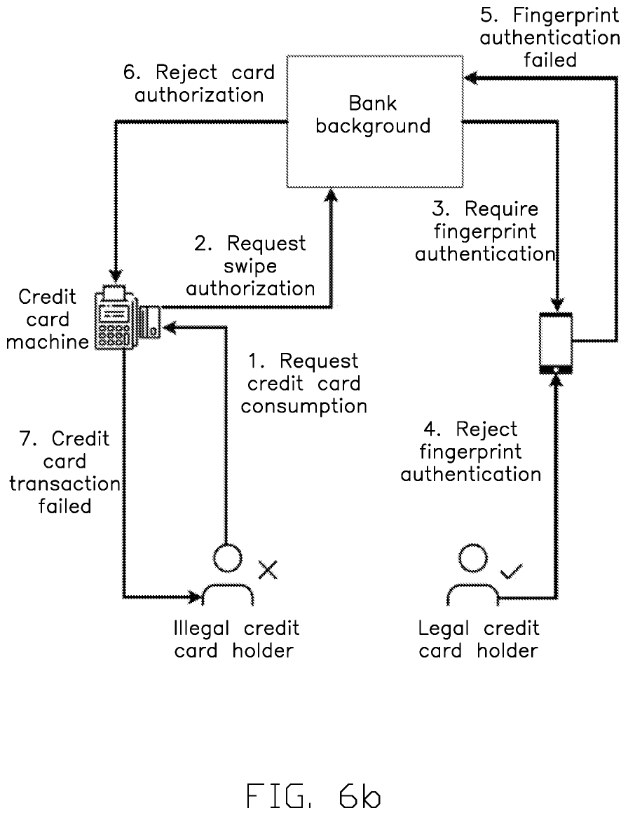

FIGS. 6a and 6b shows a flow chart of an embodiment of a credit card transaction processing method of the present disclosure.

When the customer is the legal credit card holder of the credit card, when the credit card swiping transaction is processed by the credit card machine, as shown in FIG. 6a, the first terminal device is a credit card machine, the second terminal device is a smart phone corresponding to a credit card, and the server is a bank background corresponding to the issuing bank of the credit card. The legal credit card holder of the credit card triggers a credit card transaction request, requests credit card authorization, and sends the credit card authorization request to the back background corresponding to the issuing bank of the credit card. The bank background receives the card authorization request, and sends the fingerprint authentication request to the smartphone corresponding to the credit card. The smartphone receives the fingerprint authentication request and performs fingerprint authentication on the legal credit card holder according to the fingerprint authentication request. When the fingerprint authentication in the smart phone is successful, the message of successful fingerprint authentication is sent to the bank background. The bank background issues a credit card authorization instruction to the credit card machine, and the credit card machine executes the credit card according to the credit card authorization instruction, and the credit card transaction is successful.

When the customer is the illegal credit card holder of the credit card, when processing the card swiping transaction with the swiping machine, as shown in FIG. 6b, the first terminal device is a credit card machine, the second terminal device is a smart phone corresponding to a credit card, and the server is a bank back office corresponding to the issuing bank of the credit card. The illegal credit card holder triggers a credit card transaction request, requests credit card authorization, and sends the credit card authorization request to the back background corresponding to the issuing bank of the credit card. The bank background receives the card authorization request, and sends the fingerprint authentication request to the smartphone corresponding to the credit card according to the card authorization request. The smartphone receives the fingerprint authentication request, and performs fingerprint authentication on the illegal credit card holder according to the fingerprint authentication request. When the smartphone corresponding to the credit card refuses fingerprint authentication, send a message indicating that the fingerprint authentication failed to the bank background corresponding to the credit card. The bank background issues an authorization instruction to refuse to swipe the card to the credit card machine, and the credit card machine refuses to execute the credit card according to the authorization rejection instruction, and the credit card transaction fails.

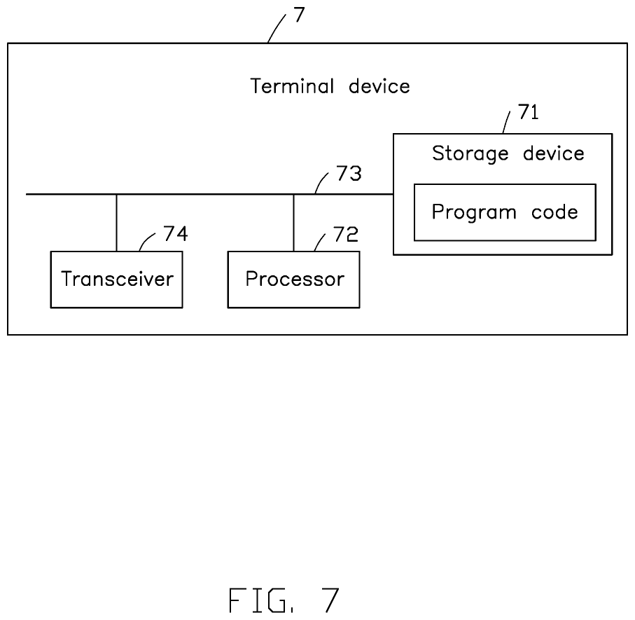

FIG. 7 illustrates a terminal device 7 in accordance with an embodiment of the present disclosure.

The terminal device 7 can further include, but is not limited to, a storage device 71, at least one processor 72, and at least one communication bus 73 and transceiver 74.

Those skilled in the art should understand that the structure of the terminal device shown in FIG. 7 does not constitute a limitation of the embodiment of the present invention. It may be a bus-type structure or a star structure. The terminal device 7 may also include a graph show more or less other hardware or software, or different component arrangements.

In one embodiment, the terminal device 7 is a terminal device that can automatically perform numerical calculation and/or information processing in accordance with pre-set or stored instructions, its hardware includes, but is not limited to, a microprocessor, an application specific integrated circuit, a programmable gate array, digital processors and embedded devices, etc. The terminal device 7 may also include a customer device. The customer device includes, but is not limited to, any electronic product that can interact with a customer through a keyboard, a mouse, a remote control, a touch panel, or a voice control device, for example, personal computers, tablets, smartphones, digital cameras, etc.

It should be noted that the terminal device 7 is only an example, and other existing or future electronic products that can be adapted to the present invention should also be included in the protection scope of the present invention and included here by reference.

The storage device 71 can be used to store the program segment. The processor 72 operates or executes the program segment stored in the storage device 71 and recalls data stored in the storage device 71, and implements various functions of the terminal device 7. The storage device 71 may include a storage program area and a storage data area, the storage program area may store an operating system, an application (such as sound playback and image playback) required for at least one function. The storage data area may store data created.

The storage device 71 may include a read-only memory (ROM), a programmable read-only memory (PROM), and an erasable programmable read-only memory (EPROM), One-time Programmable Read-Only Memory (OTPROM), Electronically-Erasable Programmable Read-Only Memory (EEPROM), and Compact Disc Read-Only Memory (CD-ROM) or other optical disk storage, magnetic disk storage, tape storage, or any other storage medium that can be used to carry or store data.

In some embodiments, the at least one processor 72 may be composed of integrated circuits, for example, may be composed of a single packaged integrated circuit, or may be composed of multiple integrated circuits with the same function or different functions, including one or a combination of multiple central processing units (CPUs), microprocessors, digital processing chips, graphics processors, and various control chips. The at least one processor 72 is the control core of the terminal device 7, which uses various interfaces and lines to connect the various components of the entire terminal device 7, and runs or executes programs stored in the storage device 71 or Modules, and call data stored in the storage device 71 to perform various functions and process data of the terminal device 7.

In some embodiments, the at least one communication bus 73 is configured to implement connection and communication between the storage device 71 and the at least one processor 72 and the like.

Although not shown, the terminal device 7 may also include a power source (such as a battery) for supplying power to various components. The power source may be logically connected to the at least one processor 72 through a power management device, thereby realize functions such as managing charging, discharging, and power consumption management. The power supply may also include any components such as one or more DC or AC power supplies, recharging devices, power failure detection circuits, power converters or inverters, and power status indicators. The terminal device 7 may also include a variety of sensors, Bluetooth modules, Wi-Fi modules, which will not be repeated here.

The above-mentioned integrated unit implemented in the form of a software function modules may be stored in a computer readable storage medium. The above-mentioned software function modules are stored in a storage medium and includes several instructions to make a computer device (which may be a personal computer, terminal device, or network device, etc.) or a processor execute the method described in each embodiment of the present invention part.

In an embodiment of the present invention, the storage device 71 stores a plurality of instructions, and the plurality of instructions are executed by the at least one processor 72 to realize the function of transaction processing.

Specifically, for the specific implementation method of the at least one processor 72 on the foregoing instructions, reference may be made to the description of the relevant steps in the corresponding embodiments of FIG. 1 to FIG. 6b, which will not be repeated here.

In some embodiments provided by the present invention, it should be understood that the disclosed device and method can be implemented in other ways. For example, the device embodiments described above are merely illustrative. For example, the division of the modules is only a logical function division, and there may be other division methods in actual implementation.

The modules described as separate components may or may not be physically separated, and the components displayed as modules may or may not be physical units, and may be located in one place or distributed on multiple network units. Some or all of the modules can be selected according to actual needs to achieve the purpose of the solution of this embodiment.

In addition, the functional modules in the various embodiments of the present invention may be integrated into one processing unit, or each unit may exist alone physically, or two or more units may be integrated into one unit. The above-mentioned integrated unit can be realized either in the form of hardware or in the form of hardware plus software functional modules.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A transaction processing method comprising:
sending a target transaction authorization request to a server corresponding to card information of a customer in a target transaction request according to the received target transaction request by a first terminal device;
receiving the target transaction authorization request, analyzing the target transaction authorization request to obtain the card information of the customer, and sending a biometric authentication request to a second terminal device corresponding to the card information by the server;
receiving the biometric authentication request, authenticating the customer according to the biometric authentication request, and sending an authentication result to the server by a second terminal device;
receiving the authentication result, sending an authorization instruction to the first terminal device when the authentication result is a successful authentication by the server; and
executing the target transaction according to the authorization instruction by the first terminal device.

2. The method according to claim 1, further comprising:
sending an authorization rejection instruction to the first terminal device when the authentication result is an authentication failure by the server; and
displaying target transaction failure information according to the authorization rejection instruction by the first terminal device.

3. The method according to claim 1, further comprising:
identifying request type of the biometric authentication request;
parsing the biometric authentication request to obtain authentication type when the request type is the first type;
obtaining a first fingerprint collected by a collection device, and performing fingerprint authentication on the first fingerprint when the authentication type is fingerprint authentication;
determining whether a first customer corresponding to the first fingerprint and a second customer corresponding to a second fingerprint in a preset fingerprint library are same customer; and
reporting the authentication result of successful authentication to the server when the first customer corresponding to the first fingerprint and the second customer corresponding to the second fingerprint in the preset fingerprint library are the same customer.

4. The method according to claim 3, further comprising:
reporting the authentication result of the authentication failure to the server when the first customer corresponding to the first fingerprint and the second customer corresponding to the second fingerprint in the preset fingerprint library are not the same customer.

5. The method according to claim 3, further comprising:
obtaining a first face feature collected by the collection device, and performing face authentication on the first face feature when the authentication type is face authentication;
determining whether the first customer corresponding to the first face feature and the second customer corresponding to a second face feature in a preset face feature library are same customer; and
reporting the authentication result of successful authentication to the server when the first customer corresponding to the first face feature and the second customer corresponding to the second face feature in the preset face feature library are the same customer.

6. The method according to claim 5, further comprising:
reporting the authentication result of the authentication failure to the server when the first customer corresponding to the first face feature and the second customer corresponding to the second face feature in the preset face feature library are not the same customer.

7. The method according to claim 3, further comprising:
parsing the biometric authentication request to obtain the target authentication type and the card information when the request type is a second type;
displaying a login interface of an APP of corresponding card issuing bank according to the card information;
collecting target biometric feature of the APP of corresponding card issuing bank according to the target authentication type when a log-in success message is monitored;
comparing the target biometric feature with the target biometric feature in the preset target database; and
reporting a successful authentication result to the server when the target biometric feature matches the target biometric feature in the preset target database.

8. The method according to claim 7, further comprising:
reporting the authentication result of the authentication failure to the server when the target biometric feature does not match the target biometric feature in the preset target database.

9. A terminal device, comprising:
a storage device; and
at least one processor, wherein the storage device stores one or more programs, when executed by the at least one processor, the one or more programs cause the at least one processor to:
send a target transaction authorization request to a server corresponding to card information of a customer in a target transaction request according to the received target transaction request;
receive the target transaction authorization request, analyze the target transaction authorization request to obtain the card information of the customer, and send a biometric authentication request to a second terminal device corresponding to the card information;
receive the biometric authentication request, authenticate the customer according to the biometric authentication request, and send an authentication result to the server by a second terminal device;
receiving the authentication result, sending an authorization instruction to a first terminal device when the authentication result is a successful authentication by the server; and
execute the target transaction according to the authorization instruction.

10. The terminal device according to claim 9, wherein the at least one processor is further caused to:
send an authorization rejection instruction to the first terminal device when the authentication result is an authentication failure; and
display target transaction failure information according to the authorization rejection instruction.

11. The terminal device according to claim 9, wherein the at least one processor is further caused to:
identify request type of the biometric authentication request;
parse the biometric authentication request to obtain authentication type when the request type is the first type;
obtain a first fingerprint collected by a collection device, and perform fingerprint authentication on the first fingerprint when the authentication type is fingerprint authentication;
determine whether a first customer corresponding to the first fingerprint and a second customer corresponding to a second fingerprint in a preset fingerprint library are same customer; and
report the authentication result of successful authentication to the server when the first customer corresponding to the first fingerprint and the second customer corresponding to the second fingerprint in the preset fingerprint library are the same customer.

12. The terminal device according to claim 11, wherein the at least one processor is further caused to:
report the authentication result of the authentication failure to the server when the first customer corresponding to the first fingerprint and the second customer corresponding to the second fingerprint in the preset fingerprint library are not the same customer.

13. The terminal device according to claim 11, wherein the at least one processor is further caused to:
obtain a first face feature collected by the collection device, and perform face authentication on the first face feature when the authentication type is face authentication;
determine whether the first customer corresponding to the first face feature and the second customer corresponding to a second face feature in a preset face feature library are same customer; and
report the authentication result of successful authentication to the server when the first customer corresponding to the first face feature and the second customer corresponding to the second face feature in the preset face feature library are the same customer.

14. The terminal device according to claim 13, wherein the at least one processor is further caused to:
report the authentication result of the authentication failure to the server when the first customer corresponding to the first face feature and the second customer corresponding to the second face feature in the preset face feature library are not the same customer.

15. The terminal device according to claim 11, wherein the at least one processor is further caused to:
parse the biometric authentication request to obtain the target authentication type and the card information when the request type is a second type;
display a login interface of an APP of corresponding card issuing bank according to the card information;
collect target biometric feature of the APP of corresponding card issuing bank according to the target authentication type when a log-in success message is monitored;
compare the target biometric feature with the target biometric feature in the preset target database; and
report a successful authentication result to the server when the target biometric feature matches the target biometric feature in the preset target database.

16. The terminal device according to claim 15, wherein the at least one processor is further caused to:
report the authentication result of the authentication failure to the server when the target biometric feature does not match the target biometric feature in the preset target database.

17. A non-transitory storage medium having stored thereon instructions that, when executed by a processor of a computer device installed in a terminal device, causes the processor to perform a transaction processing method, wherein the method comprises:
sending a target transaction authorization request to a server corresponding to card information of a customer in a target transaction request according to the received target transaction request by a first terminal device;
receiving the target transaction authorization request, analyzing the target transaction authorization request to obtain the card information of the customer, and sending a biometric authentication request to a second terminal device corresponding to the card information by the server;
receiving the biometric authentication request, authenticating the customer according to the biometric authentication request, and sending an authentication result to the server by a second terminal device;
receiving the authentication result, sending an authorization instruction to the first terminal device when the authentication result is a successful authentication by the server; and
executing the target transaction according to the authorization instruction by the first terminal device.

18. The non-transitory storage medium according to claim 17, further comprising:
sending an authorization rejection instruction to the first terminal device when the authentication result is an authentication failure by the server; and
displaying target transaction failure information according to the authorization rejection instruction by the first terminal device.

19. The non-transitory storage medium according to claim 17, further comprising:
identifying request type of the biometric authentication request;
parsing the biometric authentication request to obtain authentication type when the request type is the first type;
obtaining a first fingerprint collected by a collection device, and performing fingerprint authentication on the first fingerprint when the authentication type is fingerprint authentication;
determining whether a first customer corresponding to the first fingerprint and a second customer corresponding to a second fingerprint in a preset fingerprint library are same customer; and
reporting the authentication result of successful authentication to the server when the first customer corresponding to the first fingerprint and the second customer corresponding to the second fingerprint in the preset fingerprint library are the same customer.

20. The non-transitory storage medium according to claim 19, further comprising:
reporting the authentication result of the authentication failure to the server when the first customer corresponding to the first fingerprint and the second customer corresponding to the second fingerprint in the preset fingerprint library are not the same customer.
